(19) United States
(12) Patent Application Publication
(10) Pub. No.: US 2019/0082123 A1
(43) Pub. Date: Mar. 14, 2019

(54) DISPLAY CONTROL APPARATUS, METHOD, PROGRAM, AND SYSTEM

(71) Applicant: JVC KENWOOD Corporation, Yokohama-shi (JP)

(72) Inventor: Tetsu YAMADA, Yokohama-shi (JP)

(73) Assignee: JVC KENWOOD Corporation

(21) Appl. No.: 16/185,570

(22) Filed: Nov. 9, 2018

Related U.S. Application Data
(63) Continuation of application No. PCT/JP2017/009370, filed on Mar. 9, 2017.

(30) Foreign Application Priority Data
Jul. 21, 2016 (JP) 2016-142990

(51) Int. Cl. H04N 5/272; B60R 1/00; B62D 15/02

(52) U.S. Cl. CPC H04N 5/272; B60R 1/00; B60R 2300/806; B60R 2300/305; B62D 15/027

(57) ABSTRACT

A display control apparatus according to the present invention includes a drawing control unit configured to make a drawing unit draw a parking assisting line toward a road surface located in a parking direction of a vehicle, the parking assisting line being drawn for assisting parking of the vehicle, an image data acquisition unit configured to acquire image data obtained by shooting the parking direction including a drawing range of the parking assisting line, an extraction unit configured to extract a shape of the parking assisting line on the road surface from the image data, an image generation unit configured to generate display image data in which the extracted shape of the parking assisting line is displayed on the image data in a superimposed manner, and a display control unit configured to display the display image data in a display unit.

### CROSS REFERENCE TO RELATED APPLICATION

This application is a bypass continuation of International Application No. PCT/JP2017/009370 filed on Mar. 9, 2017, which is based upon and claims the benefit of priority from Japanese patent application No. 2016-142990, filed on Jul. 21, 2016, the disclosure of which is incorporated herein in its entirety by reference.

### BACKGROUND

The present invention relates to a display control apparatus, a method, a program, and a system.

In recent years, an apparatus that safely and accurately guides, when a vehicle is moving backward, the vehicle by drawing guidelines, which are a predicted trajectory of a backward movement of the vehicle, on a rear-view image taken by a rear camera in a superimposed manner so that the vehicle is parked through the backward movement has become widespread. Note that in Japanese Unexamined Patent Application Publication No. 2010-136289, in order to enable a driver to easily recognize three-dimensional structures such as other vehicles, a process for preventing guidelines from being superimposed on the three-dimensional structures is performed and then guidelines are displayed.

### SUMMARY

However, with the technique disclosed in Japanese Unexamined Patent Application Publication No. 2010-136289, it is difficult to cope with unevenness on a road surface and a load for its image processing is large. Therefore, there is a problem that a real-time capability is poor even for a rear-view image that is displayed when the vehicle is moving backward.

A first aspect of the embodiment provides a display control apparatus including: a drawing control unit configured to make a drawing unit draw a predicted trajectory line in a moving direction of a vehicle toward a road surface located in the moving direction of the vehicle; an image data acquisition unit configured to acquire image data obtained by shooting the moving direction of the vehicle including a drawing range of the predicted trajectory line; an extraction unit configured to extract a shape of the predicted trajectory line on the road surface from the image data; an image generation unit configured to generate display image data in which the extracted shape of the predicted trajectory line is displayed on the image data in a superimposed manner; and a display control unit configured to display the display image data in a display unit.

A second aspect of the embodiment provides a display control method including: a step of drawing a predicted trajectory line in a moving direction of a vehicle toward a road surface located in the moving direction of the vehicle; a step of acquiring image data obtained by shooting the moving direction including a drawing range of the predicted trajectory line; a step of extracting a shape of the predicted trajectory line on the road surface from the image data; a step of generating display image data in which the extracted shape of the predicted trajectory line is displayed on the image data in a superimposed manner; and a step of displaying the display image data.

A third aspect of the embodiment provides a non-transitory computer readable medium storing a display control program for causing a computer to execute: a process of making a drawing unit draw a predicted trajectory line in a moving direction of a vehicle toward a road surface located in the moving direction of the vehicle; a process of acquiring image data obtained by shooting the moving direction including a drawing range of the predicted trajectory line; a process of extracting a shape of the predicted trajectory line on the road surface from the image data; a process of generating display image data in which the extracted shape of the predicted trajectory line is displayed on the image data in a superimposed manner; and a process of displaying the display image data in a display unit.

A fourth aspect of the embodiment provides a display control system including, in addition to the display control apparatus, at least one of: a drawing unit configured to draw a predicted trajectory line toward a road surface located in a moving direction of a vehicle according to control performed by the drawing control unit; an image pickup unit configured to supply image data to the image data acquisition unit; and a display unit configured to display the display image data generated by the image generation unit according to control performed by the display control unit.

### BRIEF DESCRIPTION OF THE DRAWINGS

FIG. 1 is a block diagram showing a configuration of a display control apparatus and a display control system installed in a vehicle according to a first embodiment;

FIG. 2 is a block diagram showing an internal configuration of a drawing control unit and a drawing unit according to the first embodiment;

FIG. 3 is a diagram showing an example of an arrangement of a drawing unit and a rear camera according to the first embodiment;

FIG. 4 is a diagram showing an example of a display unit in a cabin of a vehicle equipped with a display control apparatus according to the first embodiment;

FIG. 5 is a flowchart for explaining a flow of a process for drawing parking assisting lines according to the first embodiment;

FIG. 6 is a diagram showing an example of drawing of parking assisting lines according to the first embodiment;

FIG. 7 is a flowchart for explaining a flow of a display process according to the first embodiment;

FIG. 8 is a diagram showing a display example in a display unit according to the first embodiment;

FIG. 9 is a diagram showing a display example in the display unit according to the first embodiment; and

FIG. 10 is a block diagram showing a configuration of a display control apparatus installed in a vehicle according to a second embodiment.

### DETAILED DESCRIPTION

Specific embodiments to which the exemplary embodiment is applied are explained hereinafter in detail with reference to the drawings. The same symbols are assigned to the same components throughout the drawings, and their duplicated explanations are omitted as appropriate.

### First Embodiment of Invention

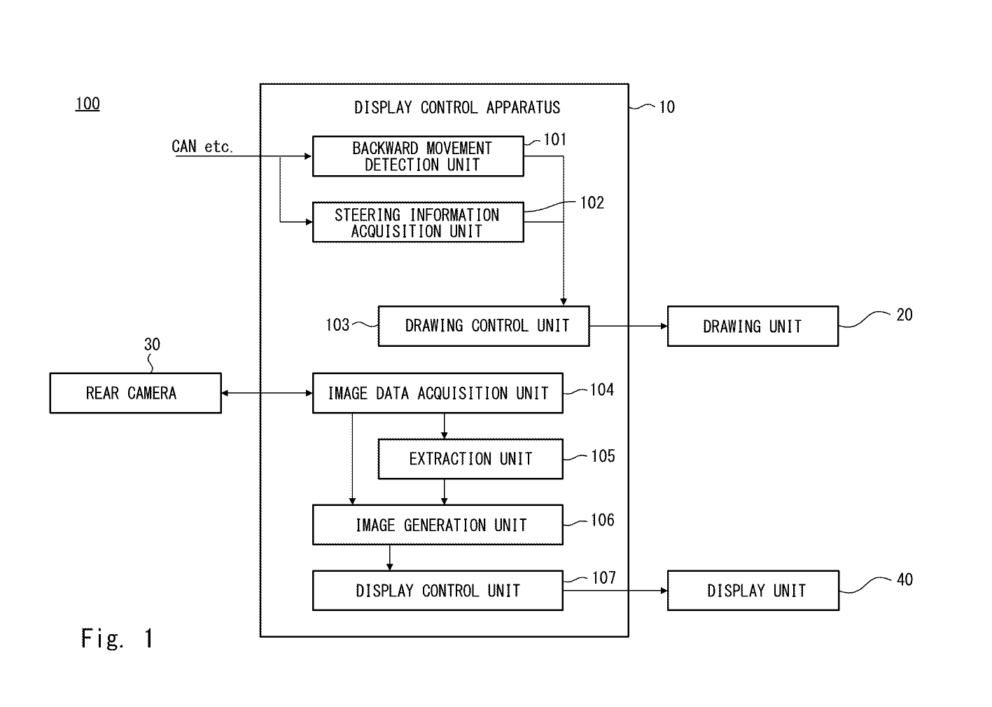

FIG. 1 is a block diagram showing a configuration of a display control apparatus 10 and a display control system 100 installed in a vehicle 1 according to a first embodiment. In addition to the display control apparatus 10, the display control system 100 includes at least one of a drawing unit 20, a rear camera 30 that serves as an image pickup unit, and a display unit 40. The vehicle 1 is equipped with the display control apparatus 10, the drawing unit 20, the rear camera 30, and the display unit 40 so that they can be used. Each of the constituents may be incorporated into the vehicle 1, or may be configured so that it can be removed from the vehicle and separately carried. The display control apparatus 10 is connected to the drawing section 20, the rear camera 30, and the display section 40. The display control apparatus 10 includes a backward movement detection unit 101, a steering information acquisition unit 102, a drawing control unit 103, an image data acquisition unit 104, an extraction unit 105, an image generation unit 106, and a display control unit 107.

The backward movement detection unit 101 detects a backward movement of the vehicle 1. For example, the backward movement detection unit 101 acquires information indicating that a reverse gear is selected from a CAN (Control Area Network) or the like, and determines whether or not the vehicle 1 is in a backward movement state. When the backward movement detection unit 101 determines that the vehicle 1 is in the backward movement state, it notifies the drawing control unit 103 of backward movement information indicating the backward movement state. The steering information acquisition unit 102 acquires a signal from the CAN or the like and thereby acquires steering angle information on steering of the vehicle 1. Note that the steering angle information also includes information on a steering direction in addition to the steering angle. The steering information acquisition unit 102 notifies the drawing control unit 103 of the acquired steering angle information. In particular, the steering information acquisition unit 102 acquires the steering angle information on the steering when the vehicle 1 is at a standstill or is moving backward.

The drawing control unit 103 acquires the backward movement information and the steering angle information, and controls the drawing unit 20. That is, the drawing control unit 103 makes the drawing unit 20 draw parking assisting lines toward a road surface located in a parking direction of the vehicle 1. Note that the drawing control unit 103 according to the first embodiment makes the drawing unit 20 draw parking assisting lines by scanning visible laser light to the road surface located in the parking direction of the vehicle 1. Further, the drawing control unit 103 preferably makes the drawing unit 20 draw parking assisting lines including a plurality of lengthwise and crosswise lines. In this way, it is possible to accurately recognize unevenness on the road surface. Further, the drawing control unit 103 preferably makes the drawing unit 20 draw parking assisting lines in a grid pattern. In this way, it is easy to visually observe small differences in level and the like.

The image data acquisition unit 104 acquires image data from the rear camera 30. The image data is image data that is obtained by having the rear camera 30 shoot the parking direction including a drawing range of parking assisting lines. Note that in this example, the parking direction is to the rear of the vehicle 1.

The extraction unit 105 extracts shapes of the parking assisting lines drawn on the road surface from the image data. The image generation unit 106 generates display image data in which the extracted shapes of the parking assisting lines are displayed on the image data in a superimposed manner. The display control unit 107 displays the display image data in the display unit 40.

The rear camera 30 is disposed in the rear of the vehicle and is a camera capable of taking images with visible light. The display unit 40 is a screen or the like that a driver of the vehicle 1 can visually observe from a driver's seat.

Note that the display control unit 10 can be implemented by a general-purpose computer apparatus. In this case, it is assumed that the display control apparatus 10 includes, as a configuration not shown in the figure, at least a control device such as a CPU (Central Processing Unit), an interface for inputting/outputting data from/to the outside, and a storage device. In this case, it is assumed that the storage device stores, as a configuration not shown in the figure, a display control program in which a display control method according to an embodiment of the exemplary embodiment is implemented. Then, the control device loads and executes the display control program stored in the storage device. In this way, the display control apparatus 10 functions as the backward movement detection unit 101, the steering information acquisition unit 102, the drawing control unit 103, the image data acquisition unit 104, the extraction unit 105, the image generation unit 106, the display control unit 107, and the like according to this embodiment by using the above-described interface as required.

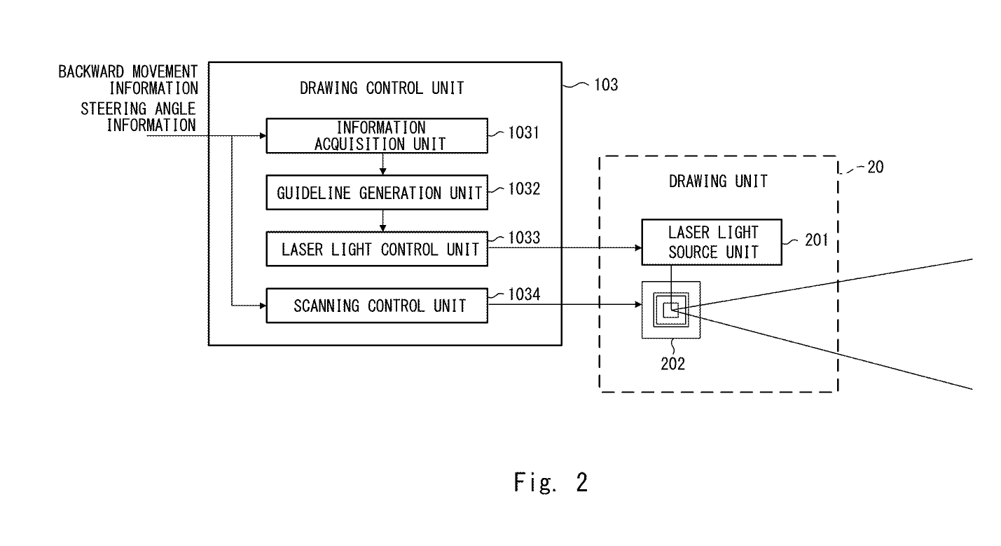

FIG. 2 is a block diagram showing an internal configuration of the drawing control unit 103 and the drawing unit 20 according to the first embodiment. The drawing control unit 103 includes an information acquisition unit 1031, a guideline generation unit 1032, a laser light control unit 1033, and a scanning control unit 1034. Further, the drawing unit 20 includes a laser light source unit 201 and a scanning mirror unit 202. The information acquisition unit 1031 acquires the backward movement information from the backward movement detection unit 101 and the steering angle information from the steering information acquisition unit 102. The guideline generation unit 1032 generates guidelines for assisting the vehicle 1 to park within a parking box by using the backward movement information and the steering angle information. The guidelines generated by the guideline generation unit 1032 are information about timings at which laser light is turned on and off during scanning of the laser light by the scanning mirror unit 202 so that guidelines are drawn by the laser light which the laser light control unit 1033 instructs the laser light source unit 201 to turn on. Note that the guidelines can also be expressed as parking assisting lines, predicted route lines, predicted trajectory lines, or the like. The laser light control unit 1033 controls the laser light source unit 201 in order to perform drawing on the road surface with laser light based on the guidelines generated by the guideline generation unit 1032. The scanning control unit 1034 controls a start of scanning or an end of the scanning by the scanning mirror unit 202 based on the backward movement information.

The laser light source unit 201 is a light source of visible laser light and emits the laser light according to an instruction from the laser light control unit 1033. The scanning mirror unit 202 reflects the laser light emitted from the laser light source unit 201 and draws parking assisting lines on the road surface. Further, the scanning mirror unit 202 moves a mirror according to a control signal from the scanning control unit 1034 so that a scanning trajectory, which is described later, is drawn. Note that the drawing unit 20 may be a projector using a transmission-type or reflection-type liquid-crystal device.

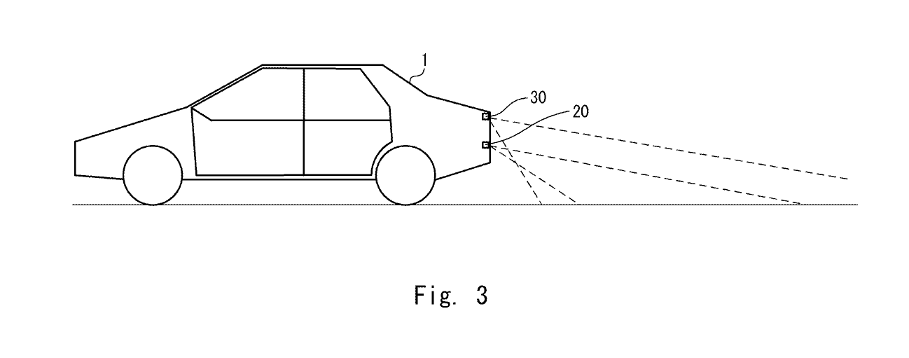

FIG. 3 is a diagram showing an example of an arrangement of the drawing unit 20 and the rear camera 30 according to the first embodiment in the vehicle 1. As shown in FIG. 3, it is assumed that a shooting range of the rear camera 30 is an area including a drawing range of the drawing unit 20.

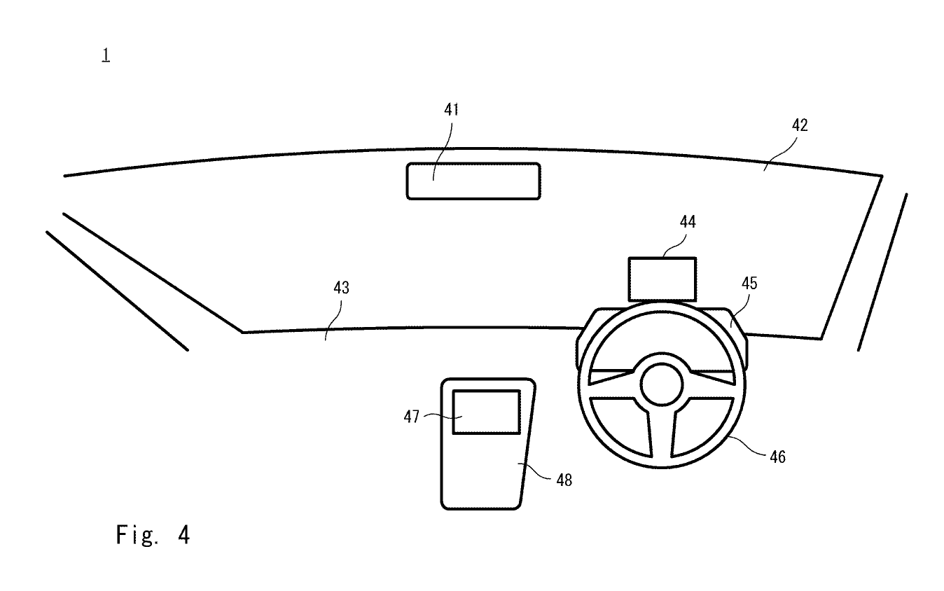

FIG. 4 is a diagram showing an example of the display unit 40 in a cabin of the vehicle 1 equipped with the display control apparatus 10 according to the first embodiment. The interior of the cabin of the vehicle 1 has an ordinary configuration and includes, for example, a steering wheel 46, a dashboard 43, a windshield 42, a center console 48, and a cluster panel 45 that displays a traveling speed of the vehicle, the number of revolutions of an engine, etc. In recent years, the center console 48 has often been equipped with a center display unit 47 that displays a navigation window or the like. Further, it is assumed that the vehicle 1 is equipped with a head-up display (Head Up Display) by which a virtual image 44 is displayed on a part of the windshield 42 located above the cluster panel 45. Note that the head-up display may be a combiner type. In this case, the virtual image 44 may be replaced by a combiner 44. A rear-view monitor 41 is disposed in the same place as the place in an ordinary vehicle where a rear-view mirror for checking a rear view is disposed, i.e., at or near the center of an upper part of the windshield 42.

Note that the display unit 40 according to the first embodiment may be one of the rear-view monitor 41, the head-up display 44, the cluster panel 45, the center display unit 47, etc. Alternatively, the display unit 40 according to the first embodiment may be a portable terminal device, such as a mobile terminal or a tablet terminal, which receives a wired or wireless signal from the display control unit 107.

Note that the display control unit 10 may be a microcomputer included in the center console 48, a computer apparatus or the like (not shown) installed in the vehicle 1, or the above-described portable terminal device.

Note that the vehicle 1 can also be expressed as a display control system 100. In such a case, the display control system 100 should include, in addition to the display control apparatus 10, at least one of the drawing unit 20, the rear camera 30, and the display unit 40. Similarly, the display control apparatus 10 should include at least the drawing control unit 103, the image data acquisition unit 104, the extraction unit 105, the image generation unit 106, and the display control unit 107.

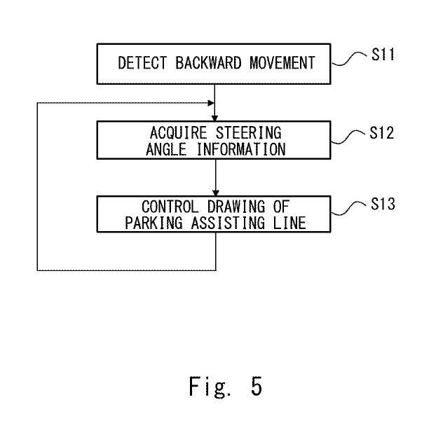

FIG. 5 is a flowchart for explaining a flow of a process for drawing parking assisting lines according to the first embodiment. Firstly, the backward movement detection unit 101 acquires information indicating that a reverse gear is selected from a CAN or the like and thereby detects that the vehicle 1 has become a backward movement state (S11). Then, the backward movement detection unit 101 sends a notification of the detection to the drawing control unit 103 as backward movement information. Next, the steering information acquisition unit 102 acquires steering angle information on the steering wheel 46 from the CAN or the like (S12) and notifies the drawing control unit 103 of the steering angle information. After that, the drawing control unit 103 controls the drawing unit 20 so that the drawing unit 20 draws parking assisting lines on the road surface located in the parking direction of the vehicle 1 based on the backward movement information and the steering angle information.

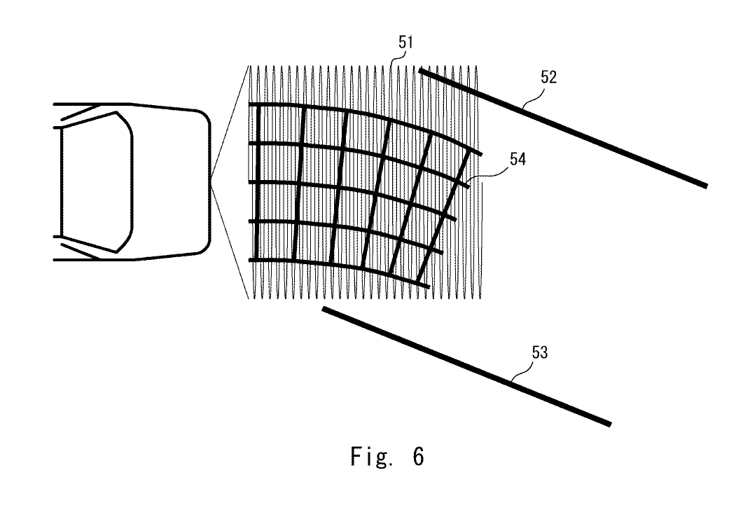

FIG. 6 is a diagram showing an example of drawing of parking assisting lines according to the first embodiment. The drawing unit 20 swings the scanning mirror unit 202 so that laser light reflected by the scanning mirror unit 202 can be scanned along a scanning trajectory 51, and draws parking assisting lines 54 on the road surface by repeatedly turning on and off the laser light source unit 201 according to control of the drawing control unit 103 so that the vehicle 1 can be parked between parking partition lines 52 and 53. That is, the drawing unit 20 draws parking assisting lines by scanning visible laser light on the road surface located in the parking direction of the vehicle 1. Further, the drawing unit 20 draws the parking assisting lines including a plurality of lengthwise and crosswise lines. Further, the drawing unit 20 draws the parking assisting lines in a grid pattern.

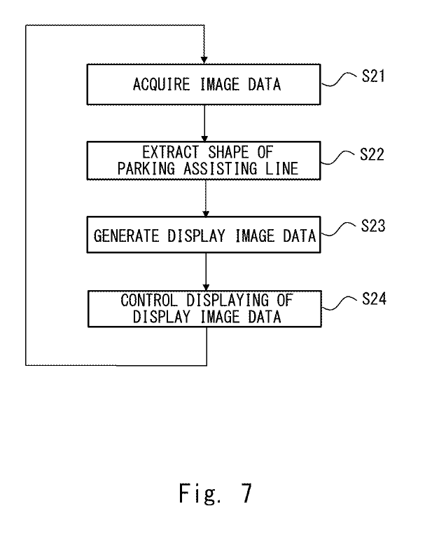

FIG. 7 is a flowchart for explaining a flow of a display process according to the first embodiment. Firstly, the rear camera 30 shoots a peripheral road surface including the parking assisting lines 54 drawn by the drawing unit 20. Then, the image data acquisition unit 104 acquires image data taken by the rear camera 30 (S21). Next, the extraction unit 105 extracts shapes of the parking assisting lines on the road surface from the image data (S22). In this process, when there is unevenness or the like on the road surface, shapes that are different from the shapes drawn in the step S13 are extracted. Then, the image generation unit 106 draws the shapes of the parking assisting lines extracted in the step S22 on a place where the parking assisting lines are drawn in the image data acquired in the step S21 in a superimposed manner and thereby generates display image data for display (S23). After that, the display control unit 107 controls the display unit 40 so that it displays the display image data generated in the step S23 (S24).

In the extraction of the shapes of the parking assisting lines on the road surface performed in the step S22, when the laser light is visible laser light, the parking assisting lines are extracted by extracting a wavelength component of the visible laser from the image data acquired by the image data acquisition unit 104 and performing a known extraction process such as an edge detection process. The image data acquired by the image data acquisition unit 104 includes various information items including the same wavelength component as that of the visible laser. Therefore, the extraction of the shapes of the parking assisting lines may be performed after specifying a range where the parking assisting lines are drawn in the shooting range of the rear camera 30 in advance.

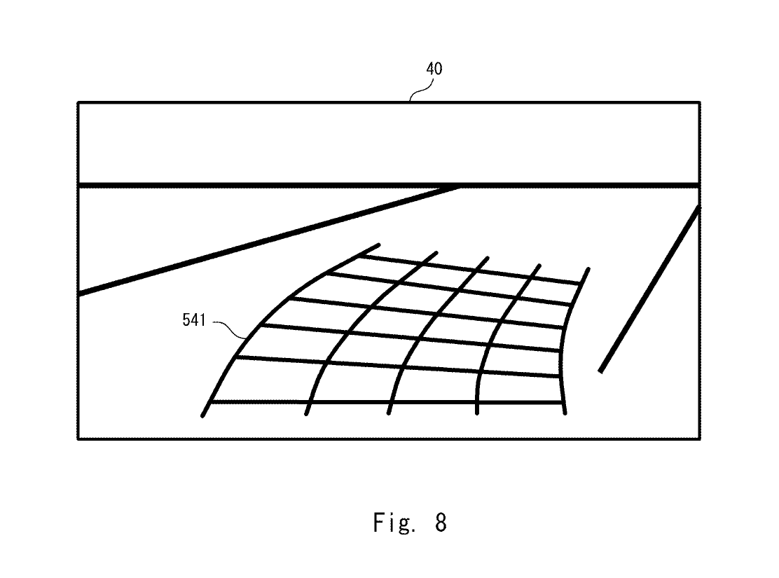

FIG. 8 is a diagram showing a display example of the display unit 40 according to the first embodiment. This example shows that since the amount of unevenness on the road surface is small, the displayed shapes of parking assisting lines 541 are substantially the same as those of the parking assisting lines 54 drawn in the step S13.

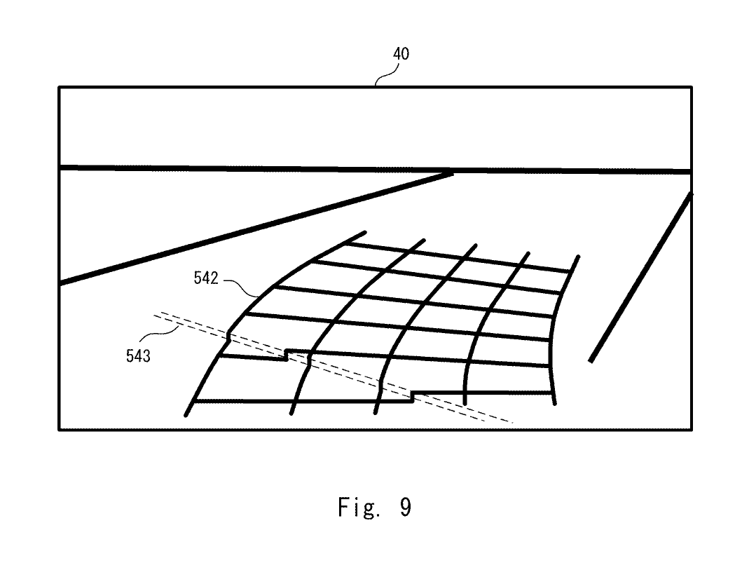

FIG. 9 is a diagram showing another display example of the display unit 40 according to the first embodiment. This example shows that since unevenness on the road surface is prominent, the shapes of parking assisting lines 542 differ from those of the parking assisting lines 54 drawn in the step S13, thus enabling a driver to easily recognize a difference in level 543.

Note that in Japanese Unexamined Patent Application Publication No. 2010-136289, a process for preventing guidelines from being superimposed on three-dimensional structures is performed as described above. Therefore, the load for the image processing is large and there is a possibility that a real-time capability could be poor when image data taken by the rear camera is displayed on the screen. In contrast to this, in the first embodiment, two-dimensional shapes of guidelines are extracted as they are from the image including the guidelines scanned on the road surface and superimposed on the display image data. Therefore, in the first embodiment, the load for the image processing is smaller than that in Japanese Unexamined Patent Application Publication No. 2010-136289 or the like. Therefore, a delay in displaying the display image data in the display unit 40 is small and hence the real-time capability for the image data can be ensured. Further, it is possible to display guidelines in which unevenness on the road surface is reflected on the screen, thus enabling a driver to easily recognize the unevenness.

Further, when the laser light for drawing guidelines is visible light, the guidelines drawn on the road surface can be visibly observed. Therefore, at night or the like, in particular, it is possible to warn other people around the vehicle 1 that the vehicle will move backward and of its moving direction.

However, in the case of daytime with fine weather or the like, even when the laser light is visible light, a driver can hardly recognize the guidelines when image data taken by the rear camera is displayed as it is in the display unit 40. Therefore, the image generation unit 106 according to the first embodiment superimposes and displays the shapes of parking assisting lines extracted by the extraction unit 105 with a color different from the color of the road surface in the image data acquired by the image data acquisition unit 104. By doing so, it is possible to clearly display the guidelines in which unevenness on the road surface is reflected.

Note that when a difference in level is included in the extracted shapes of the extracted parking assisting lines, the image generation unit 106 preferably generates display image data while displaying the difference in level in an emphasized manner. Regarding the shape corresponding to the difference in level in the extracted shapes of the parking assisting lines, the presence of the difference in level is detected by, for example, a process for extracting a part at which the direction of the extracted shapes of the parking assisting lines is discontinuous or disconnected. In FIG. 9, because of the presence of the difference in level 543, a part of the parking assisting lines 542 is drawn on a surface forming the difference in level 543. As a result, the extracted shapes of the parking assisting lines become discontinuous, i.e., become crank-like shapes. Regarding the detection of the shape corresponding to the difference in level in the extracted shapes of parking assisting lines, the shape may be detected by comparing the extracted shapes of the parking assisting lines with the shapes of the parking assisting lines that would be drawn on the assumption that the road surface is flat. In this way, a driver can recognize the difference in level on the road surface more easily. This feature may be particularly useful for drivers of vehicles having small vehicle heights.

### Second Embodiment of Invention

A second embodiment according to the exemplary embodiment is a modified example of the above-described first embodiment and uses infrared light as the laser light for the drawing.

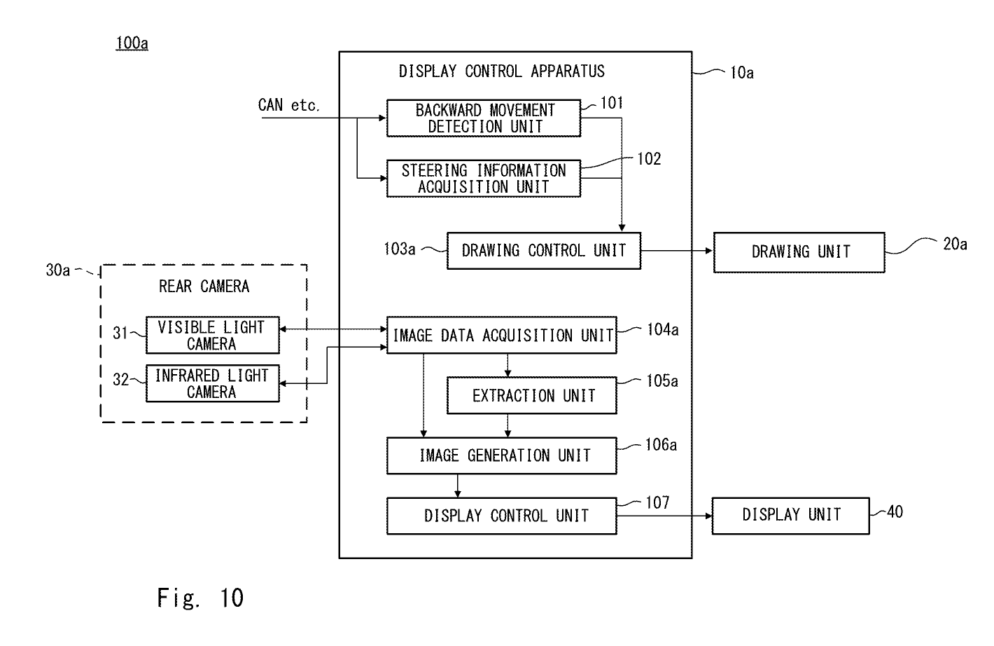

FIG. 10 is a block diagram showing a configuration of a display control apparatus 10a and a display control system 100a according to the second embodiment. Compared to FIG. 1, in FIG. 10, the drawing unit 20, the rear camera 30, the image data acquisition unit 104, the extraction unit 105, and the image generation unit 106 are replaced by a drawing unit 20a, a rear camera 30a, a drawing control unit 103a, an image data acquisition unit 104a, an extraction unit 105a, and an image generation unit 106a, respectively. Other configurations are similar to those in FIG. 1 and therefore their descriptions are omitted as appropriate.

The drawing unit 20a is obtained by modifying the configuration corresponding to the laser light source unit 201 in FIG. 2 to a light source of infrared laser light. Therefore, it is considered that the drawing control unit 103a according to the second embodiment makes the drawing unit 20a draw parking assisting lines by scanning infrared laser light on the road surface located in the parking direction of the vehicle 1.

The rear camera 30a includes a visible light camera 31 and an infrared light camera 32. That is, the rear camera 30a is a camera capable of taking images with visible light and infrared light. Note that the infrared light camera 32 may be a camera that is obtained by removing an infrared light removal filter from the configuration equivalent to that of the visible light camera 31, or may be a single camera capable of taking images with both visible light and infrared light.

The image data acquisition unit 104a acquires image data taken by the rear camera 30a. Note that the image data acquisition unit 104a may be capable of separately acquiring a visible light image and an infrared light image. The extraction unit 105a extracts the shapes of the parking assisting lines on the road surface from the image data by the infrared light acquired by the image data acquisition unit 104a. The image generation unit 106a displays the shapes of the parking assisting lines extracted by the extraction unit 105a on the image data by the visible light acquired by the image data acquisition unit 104a in a superimposed manner.

When the laser light is infrared light, the parking assisting lines can be appropriately extracted either in the daytime or in the night because the image data taken by the rear camera 30a is acquired in a separated manner as described above.

### Other Embodiments of Invention

Note that operations that are performed when the vehicle is moving backward are described in the first and second embodiments. However, the embodiment is not limited to such cases. That is, this embodiment can also be applied to operations that are performed when the vehicle is moving forward, e.g., the vehicle is parked by a forward movement. In such a case, a front camera may be used in place of the rear camera 30 in FIG. 1 or the rear camera 30a in FIG. 10. Further, in the above-described first and second embodiments, it is described that parking assisting lines are drawn based on the steering angle information. However, parking assisting lines corresponding to a straight movement or to a maximum steering angle may be drawn without using the steering angle information.

The present disclosure has been explained above with the above-described embodiments. However, the exemplary embodiment is not limited to the configurations of the above-described embodiments, and needless to say, various modifications, corrections, and combinations that can be made by those skilled in the art are also included in the scope of the invention specified in the claims of the present application.

Further, any of the processes in the above-described vehicle-mounted apparatuses can also be implemented by causing a CPU (Central Processing Unit) to execute a computer program. In such cases, the computer program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

Further, in addition to the cases where the functions of the above-described embodiment are implemented by causing a compute to execute a program that is used to implement functions of the above-described embodiment, other cases where the functions of the above-described embodiment are implemented with cooperation with an OS (Operating System) or application software running on the computer are also included in the embodiment of the exemplary embodiment. Further, other cases where all or part of the processes of this program are executed by a function enhancement board inserted into the computer or a function enhancement unit connected to the compute to implement the functions of the above-described embodiment are also included in the embodiment of the exemplary embodiment.

According to the embodiment, it is possible to provide a display control apparatus, a method, a program, and a system for displaying parking assisting lines in accordance with shapes of a road surface with a high real-time capability.

The exemplary embodiment can be applied to display control apparatuses installed in movable objects, including vehicles, equipped with cameras or the like, and have industrial applicability.

What is claimed is:

1. A display control apparatus comprising:
a drawing control unit configured to make a drawing unit draw a predicted trajectory line in a moving direction of a vehicle toward a road surface located in the moving direction of the vehicle;
an image data acquisition unit configured to acquire image data obtained by shooting the moving direction of the vehicle including a drawing range of the predicted trajectory line;
an extraction unit configured to extract a shape of the predicted trajectory line on the road surface from the image data;
an image generation unit configured to generate display image data in which the extracted shape of the predicted trajectory line is displayed on the image data in a superimposed manner; and
a display control unit configured to display the display image data in a display unit.

2. The display control apparatus according to claim 1, wherein
the drawing control unit makes the drawing unit draw the predicted trajectory line by scanning visible laser light on the road surface located in the moving direction of the vehicle, and
the image data acquisition unit acquires the image data taken by a camera capable of taking an image with visible light.

3. The display control apparatus according to claim 1, wherein
the drawing control unit makes the drawing unit draw the predicted trajectory line by scanning infrared laser light on the road surface located in the moving direction of the vehicle,
the image data acquisition unit acquires the image data taken by a camera capable of taking an image with visible light and infrared light,
the extraction unit extracts a shape of the predicted trajectory line on the road surface from the image data by the infrared light acquired by the image data acquisition unit, and
the image generation unit displays the extracted shape of the predicted trajectory line on the image data by the visible light acquired by the image data acquisition unit.

4. The display control apparatus according to claim 1, wherein the drawing control unit makes the drawing unit draw the predicted trajectory line including a plurality of lengthwise and crosswise lines.

5. The display control apparatus according to claim 4, wherein the drawing control unit makes the drawing unit draw the predicted trajectory line in a grid pattern.

6. The display control apparatus according to claim 1, wherein when a difference in level is included in the extracted shape of the extracted predicted trajectory line, the image generation unit generates the display image data while displaying the difference in level in an emphasized manner.

7. The display control apparatus according to claim 1, wherein the image generation unit displays the extracted shape of the predicted trajectory line with a color different from a color of the road surface in the image data in a superimposed manner.

8. The display control apparatus according to claim 1, further comprising a steering information acquisition unit configured to acquire steering angle information on steering of the vehicle when the vehicle is moving at a low speed, wherein
the drawing control unit makes the drawing unit draw the predicted trajectory line on the road surface located in the moving direction of the vehicle based on the steering angle information on the steering of the vehicle.

9. A display control method comprising:
a step of drawing a predicted trajectory line in a moving direction of a vehicle toward a road surface located in the moving direction of the vehicle;
a step of acquiring image data obtained by shooting the moving direction including a drawing range of the predicted trajectory line;
a step of extracting a shape of the predicted trajectory line on the road surface from the image data;
a step of generating display image data in which the extracted shape of the predicted trajectory line is displayed on the image data in a superimposed manner; and
a step of displaying the display image data.

10. A non-transitory computer readable medium storing a display control program for causing a computer to execute:
a process of making a drawing unit draw a predicted trajectory line in a moving direction of a vehicle toward a road surface located in the moving direction of the vehicle;
a process of acquiring image data obtained by shooting the moving direction including a drawing range of the predicted trajectory line;
a process of extracting a shape of the predicted trajectory line on the road surface from the image data;
a process of generating display image data in which the extracted shape of the predicted trajectory line is displayed on the image data in a superimposed manner; and
a process of displaying the display image data in a display unit.

11. A display control system comprising:
a display control apparatus according to claim 1; and
at least one of a drawing unit configured to draw a predicted trajectory line toward a road surface located in a moving direction of the vehicle according to control performed by the drawing control unit; an image pickup unit configured to supply image data to the image data acquisition unit; and a display unit configured to display the display image data generated by the image generation unit according to control performed by the display control unit.
